(19) United States
(12) Patent Application Publication
(10) Pub. No.: US 2002/0131416 A1
(43) Pub. Date: Sep. 19, 2002

(54) Dynamic set-up of ATM bearers for AAL2 connections

(76) Inventors: Stefan Pudas, Sundbyberg (SE); Gunnar Larsson, Tumba (SE); Goran Eneroth, Tyreso (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/812,124

(22) Filed: Mar. 19, 2001

(51) Int. Cl. H04L 12/28

(52) U.S. Cl. 370/395.1; 370/399

(57) ABSTRACT

A system and method for optimizing network resources in an ATM network wherein existing virtual channel connections (“VCCs”) are checked for an available channel identifier (“CID”) and network bandwidth in response to a connection request. If a CID and required bandwidth is not available, then a new VCC is established and the requested AAL2 connection is setup. Rather than establishing a new direct VCC, available resources on an indirect VCC may be used.

### BACKGROUND

This invention generally relates to dynamic channel allocation in communication networks. More particularly, the present invention provides a method for bandwidth management of asynchronous transfer mode (“ATM”) network channels using ATM adaption layer 2 (“AAL2”).

ATM is a standard protocol for transmitting asynchronous telecommunications data. This protocol is based on the transmission of data in fixed-length data packets known as ATM Cells. Each ATM cell consists of a header portion and payload portion. To be able to accommodate different types of telecommunications data, a number of ATM Adaptation Layers (“AALs”) have been standardized. Of special interest for this application is AAL2, which is designed to carry low-bandwidth delay-sensitive telecommunications data. AAL2 encapsulates the telecommunications data to form an AAL2 header portion (separate from the ATM header portion) that contains several fields, including a channel identifier (“CID”) and a variable length payload portion. This is called an AAL2 minicell. Depending of the total length of the individual minicells several minicells can be multiplexed into the payload portion of an ATM Cell.

AAL2 also allows for several data streams to be multiplexed onto a single ATM virtual connection channel (“VCC”), thereby facilitating the carrying of low-speed, delay-sensitive data. Typically, an ATM network connection is either a permanent virtual connection (“PVC”) or a switched virtual connection (“SVC”). AAL2 switching functions may be utilized to direct different AAL2 data streams multiplexed on one ATM VCC to different destinations. AAL2 switching and termination functions may be integrated in an ATM switch as AAL2 connections are carried on ATM VCCs. The AAL2 connections form a logical AAL2 network, but the AAL2 network is physically inseparable from the ATM network. The mechanism for bandwidth management on ATM and the coupling between the data streams carried on AAL2 and the underlying ATM bearer will be discussed in more detail later in this application.

In many applications, pre-configured PVCs are used to set-up ATM VCCs for AAL2. The number of PVCs needed for an application may be calculated based on traffic estimations. In order to ensure operation under peak-usage conditions, the traffic estimations should represent the worst-case usage requirements.

One drawback to using pre-configured PVCs is the inability to adapt to changing network usage requirements, especially short term requirements. To meet changing network usage requirements, dynamic trunking may be used. Dynamic trunking enables network operators to set up and release network resources dynamically according to traffic load. A dynamic trunk in the ATM network may consist of several on-demand SVCs that may be automatically established and released according to traffic load requirements.

FIG. 1 depicts a block diagram of an AAL2 network 100 having indirect VCCs. An indirect VCC may include multiple VCCs, wherein two of the VCCs have their endpoints at the ATM switches that constitute the endpoints of the logical AAL2 connections that are set-up over the VCC. The other VCCs connect the first two VCCs together at AAL2 switching capable ATM switches to form a single transmission path for AAL2 minicells. The number of VCC sections could be two, in which case the two VCCs would meet in just one intermediate ATM switch.

By way of illustration, the network in FIG. 1 consists of five AAL2 switching capable ATM nodes, 101, 102, 103, 104, and 105 and four physical ATM network connections 111, 112, 113, and 114. Four of these nodes, 101-104, act as endpoints while the fifth node, 105, acts as the AAL2 switch. As can be appreciated, each node may be implemented using one or more pieces of known networking equipment. Examples of networking equipment that could be used to implement the network shown in FIG. 1 include Ericsson's AXD 301 ATM switch and the Cello system. Other examples will be apparent to those skilled in the art.

The logical AAL2 connections 121, 122, 123, and 124 are established between each respective endpoint 101-104 and the switch 105. ATM cells may be sent from any endpoint to any other endpoint through the switch. Thus, there are no direct connections between the endpoints; the switch 105 must determine the destination of each cell and direct the cell accordingly. The processing of each cell adds some network delay and requires processing power. During times of high network use, the switch 105 may not have enough processing power to handle the high load. This may result in excessively long delays that can negatively impact network performance.

In FIG. 2, where like items bear the same item numbers as in FIG. 1, two direct VCCs 201 and 202 are also shown. A direct VCC may be defined as a single VCC that has its endpoints at the ATM nodes that constitute the endpoints of the logical AAL2 connections that are set-up over the VCC. Because direct connections must follow the physical ATM network connections, the direct connections also pass through the switching node 105. However, unlike those on the indirect connections 121-124, ATM cells transmitted on direct connections 201, 202 are only processed by the ATM switching portion of switch 105. Thus, during times of high network use, the cells transmitted by direct connections 201, 202 do not experience the same processing delays as those on the indirect connections 121-124. In practice, a mix of both indirect and direct VCCs will exist in the network.

One drawback of conventional systems is that the set-up of PVCs may lay a heavy management burden on the operator and may also lead to lower bandwidth efficiency. In practice, the management burden will severely limit the number of nodes in a network.

Optimization of VCCs is another problem. The operator is faced with the choice of either setting up direct VCCs between the AAL2 endpoints or utilizing the AAL2 switching capacity in intermediate nodes.

Accordingly, there is a need to provide a method of efficiently allocating network resources to meet changing demands for network bandwidth. Preferably, this method should also reduce the management burden on the network operator.

### SUMMARY

In accordance with the present invention, a function that monitors certain parameters and an algorithm to automatically set-up ATM VCCs between different AAL2 destinations when the need arises is used. The algorithm can choose between setting up a VCC directly to a destination or just to some intermediate AAL2 switching node depending on, for example, a threshold value for the total bandwidth between two AAL2 endpoints. It will be apparent to those skilled in the art that there are other threshold values and parameters that may be relevant.

New VCCs may be set-up with a configurable amount of bandwidth. The amount of bandwidth is determined to be appropriate for a number of new AAL2 connections. The number of AAL2 connections in a new VCC is optimized to maximize the bandwidth efficiency and at the same time large enough to avoid loading the network with excessive signaling.

In accordance with one aspect of the invention, there is a method for optimizing network resources in an ATM network. The method includes determining whether a channel identifier (“CID”) is available on a direct virtual connection channel (“VCC”) in response to a connection request. If a CID is available, then it is determined if bandwidth is available on the direct VCC. If bandwidth is available on the direct VCC, then an AAL2 connection is setup on the direct VCC.

In accordance with another aspect of the invention, there is a method for optimizing network resources in an ATM network, wherein the ATM network is formed from a plurality of interconnected network nodes. The method includes determining whether a channel identifier (“CID”) is available on an indirect virtual connection channel (“VCC”). If the indirect VCC does not have an available CID, then all existing indirect VCCs are checked for an available CID. If the indirect VCC has an available CID, then it is determined if bandwidth is available on the indirect VCC. If the indirect VCC does not have bandwidth available, then the bandwidth on the indirect VCC is modified. If bandwidth is available on the indirect VCC, then an AAL2 connection is setup on the indirect VCC.

In accordance with another aspect of the invention, there is a communication network having a plurality of ATM nodes and a plurality of direct virtual connection channels (“VCC”). Each direct VCC connects one of the plurality of ATM nodes to a different one of the plurality of ATM nodes. The network also includes means for determining whether a channel identifier (“CID”) is available on a direct VCC, means for determining if bandwidth is available on the direct VCC, and means for setting up an AAL2 connection on the direct VCC.

In accordance with still another aspect of the invention, there is a communication network having a plurality of ATM nodes and a plurality of indirect virtual connection channels (“VCC”). Each indirect VCC connects one of the plurality of ATM nodes to a different one of the plurality of ATM nodes. The network also includes means for determining whether a channel identifier (“CID”) is available on an indirect VCC, means for checking all existing indirect VCCs for an available CID, means for determining if bandwidth is available on the indirect VCC, means for modifying the bandwidth on the indirect VCC, and means for setting up an AAL2 connection on the indirect VCC.

In accordance with yet another aspect of the invention, there is an ATM node having means for connecting to at least one other ATM node. The connecting means is capable of establishing a virtual connection channel (“VCC”) between the ATM node and at least one other ATM node. The ATM node also includes means for determining whether a channel identifier (“CID”) is available on the VCC, means for modifying the bandwidth on the VCC, and means for setting up an AAL2 connection on the VCC.

It should be emphasized that the term “comprises” or “comprising,” when used in this specification, is taken to specify the presence of stated features, integers, steps, or components, but does not preclude the presence or addition of one or more other features, integers, steps, components, or groups thereof.

### BRIEF DESCRIPTION OF DRAWINGS

The objects and advantages of the invention will be understood by reading the following detailed description in conjunction with the drawings in which:

FIG. 1 is a block diagram of an AAL2 network having indirect VCCs;

FIG. 2 is a block diagram of an AAL2 network having direct and indirect VCCs;

FIG. 3 is a function diagram of a decision algorithm;

FIG. 4 is a flow diagram of a decision algorithm consistent with a first embodiment of the invention; and

FIG. 5 is a flow diagram of a decision algorithm consistent with a second embodiment of the invention.

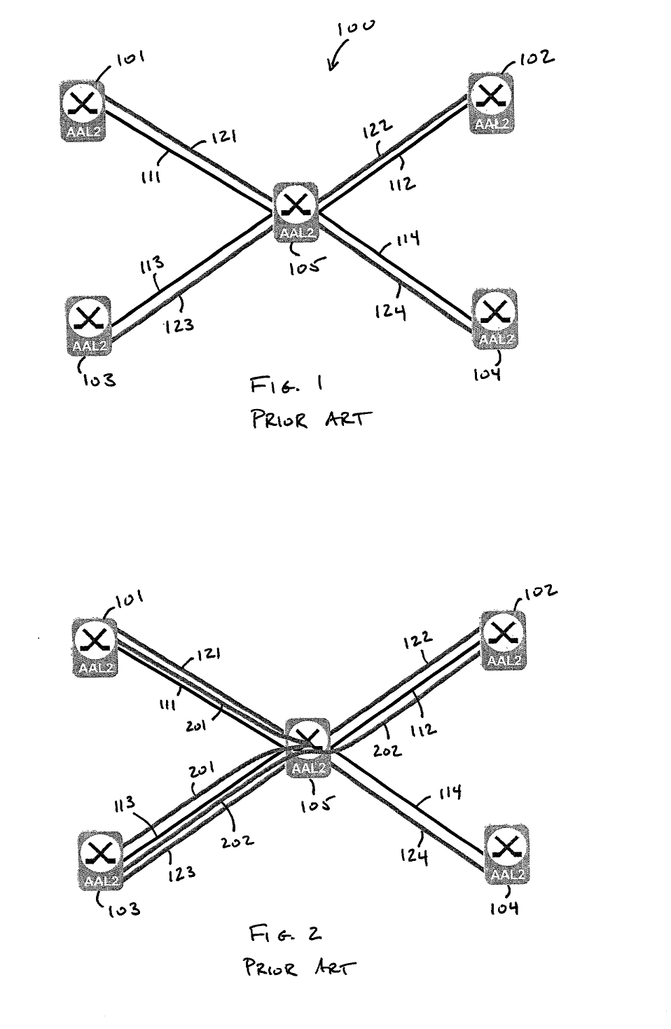

### DETAILED DESCRIPTION

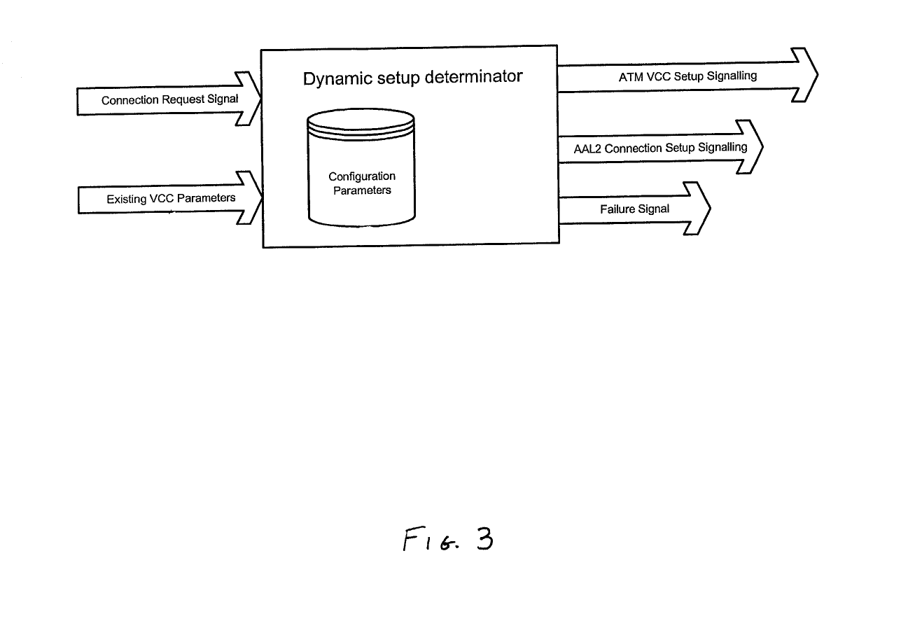

The present invention involves a method for dynamically establishing VCCs and optimizing the amount of bandwidth allocated to the VCC to optimize bandwidth efficiency while minimizing the amount of network signaling. While the invention is described in terms of an algorithm, it is considered well within the abilities of those skilled in the art to implement the algorithm using known network design and programming techniques. For example, the algorithm described herein may be implemented in a network configuration like that shown in FIG. 2.

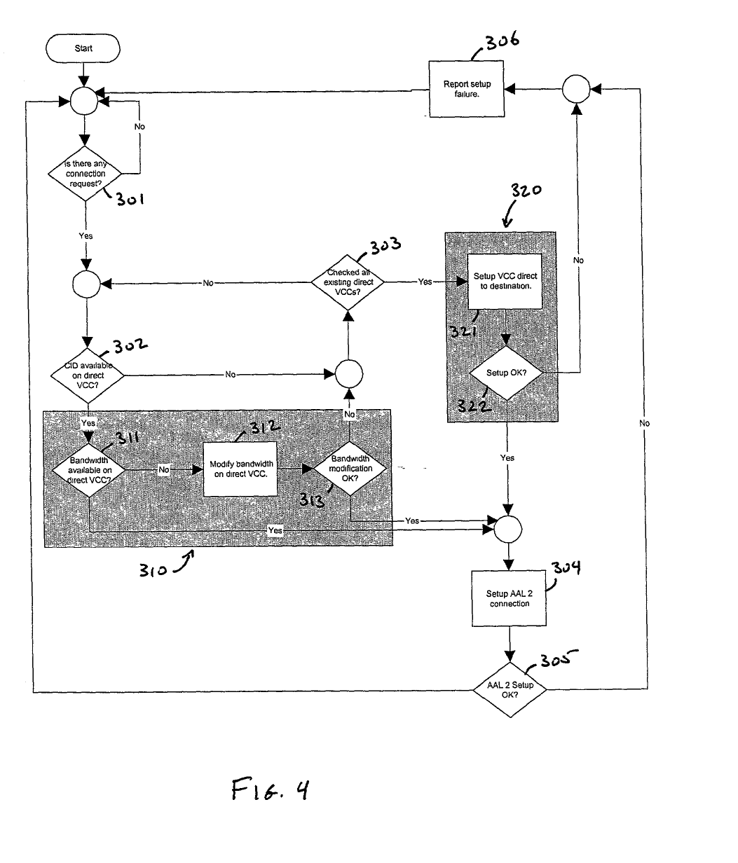

FIG. 3 depicts a function diagram consistent with the invention. The invention generally consists of a monitoring function that monitors the parameters of existing VCCs. These parameters include available CIDs and the available bandwidth on VCCs. As can be appreciated, these parameters may be collected for every VCC, or for a sub-set of VCCs. Those skilled in the art will recognize that the sub-set of VCCs may be chosen based on a variety of network management parameters.

When a connection request signal is received to initiate a call setup to a specific destination, a dynamic setup determinator algorithm evaluates the VCC parameters and initiates different actions depending on the evaluation result. The VCC parameters are evaluated against a set of configuration parameters. The configuration parameters may include a threshold for the number of AAL2 connections on a VCC and the total bandwidth allocated to a particular call destination. These configuration parameters may be pre-configured and typically are not changed during normal operation. This is not to say that the configuration parameters cannot be changed during normal operation. It is well know that network configuration parameters may be changed based on a variety of events, such as time of day, in order to optimize network resources based on predetermined events.

As a result of the evaluation of the VCC parameters and the configuration parameters, the algorithm may initiate different actions. These actions include network functions, such as initiating ATM VCC setup signaling and initiating AAL2 connection setup signaling. The algorithm may also generate internal signals, such as a failure signal. The internal signals may be used within the management algorithm or may be used to generate additional network signals.

As can be appreciated, network protocols exist which may be used to carry out various steps of the algorithm. For example, the commands needed to execute a connection request, bandwidth modification, or setting up of a VCC are defined by industry standards and are considered to be known to the art. Accordingly, the explicit disclosure of specific network commands is not necessary to understand the invention.

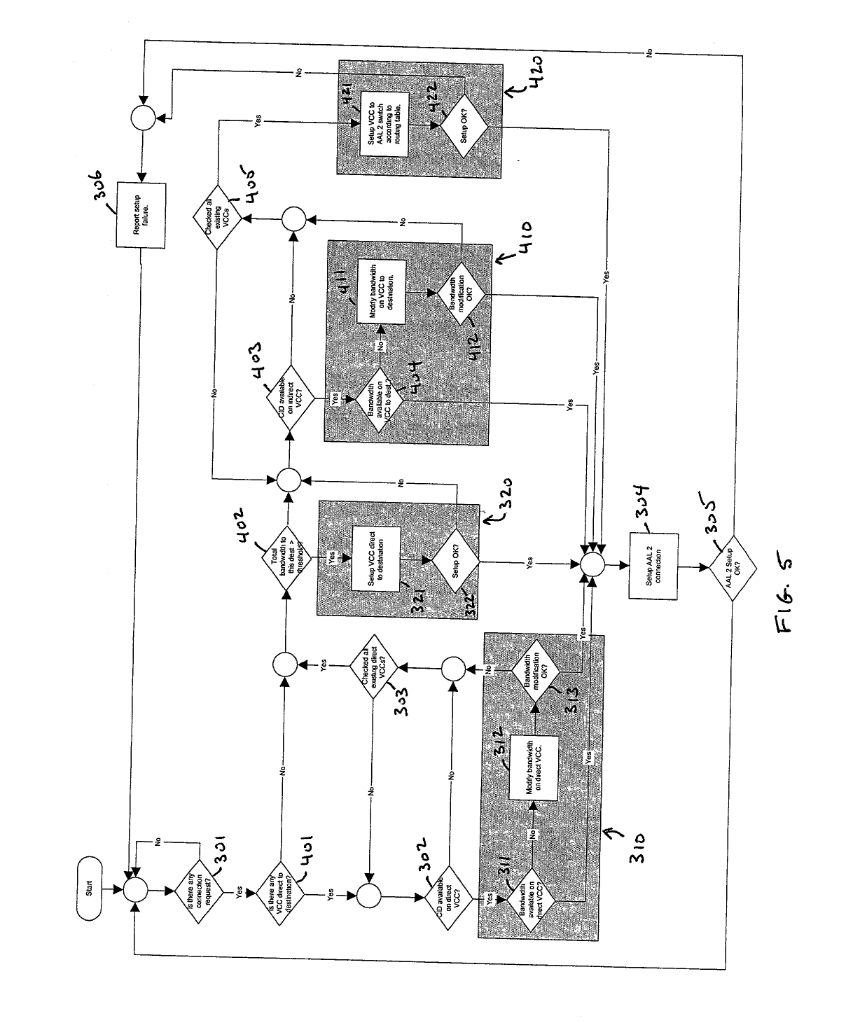

FIG. 4 depicts a flowchart for the decision algorithm. As can be appreciated, the decision algorithm may be but one function of a more extensive management system. Other functions of the management system may include a monitoring function, which monitors available CIDs per VCC, available bandwidth per VCC, and total bandwidth to an AAL2 destination. The total bandwidth usage may be monitored on a per destination basis and reported to the management system. As can be appreciated, these functions and parameters are offered as examples, and other suitable functions and parameters would be apparent to those skilled in the art.

The management system may also include a function which predicts the bandwidth needed by a specific AAL2 destination. This prediction may be based upon such factors as mean bandwidth utilization, variance, and trends. The algorithm may also have some hysteresis to avoid frequent adjustments of bandwidth. If the algorithm concludes that the bandwidth need has changed, then the algorithm may signal the initiation function.

Returning to FIG. 4, upon receipt (step 301) of a connection request, the algorithm determines (step 302) if a CID is available on a direct VCC. If a CID is available, then the algorithm evaluates (step 310) the available bandwidth. The bandwidth evaluation begins by determining (step 311) if there is bandwidth available on a direct VCC. Normally, the bandwidth can be modified if the number of AAL2 connections on a VCC is lower than the maximum possible number, namely 248 AAL2 connections per VCC. Rather than using the maximum number of AAL2 connections on a VCC, the apparatus may use a configurable number that is lower than 248. If there is bandwidth available on the VCC, then no bandwidth modification is necessary and the bandwidth evaluation is concluded. If there is not sufficient bandwidth on a direct VCC, then the algorithm first attempts to modify (step 312) the bandwidth on the direct VCC. If this is successful (step 313), then the bandwidth evaluation is concluded. If not, then the algorithm determines (step 303) if all of the existing direct VCCs have been checked. If they have not been checked, then steps 302, 310, and 303 are repeated until either sufficient bandwidth on a direct VCC has been obtained or all of the existing direct VCCs have been evaluated.

If all of the existing direct VCCs have been evaluated and sufficient bandwidth has not been found, then the algorithm attempts to establish (step 320) a new direct VCC. Typically, if the number of AAL2 connections on available VCCs is higher than the threshold or if the maximum number of AAL2 connections has been reached, then a new VCC is needed. To establish a new VCC, the algorithm first attempts to establish (step 321) a direct VCC to the destination using standard ATM signaling protocols and then determines (step 322) if the direct VCC was successfully established. If the VCC was not established, then a setup failure is reported (step 306) to the management system and the algorithm returns to a monitoring state (step 301).

If a new direct VCC is established (step 320) or the bandwidth of an existing VCC was successfully modified (step 310), then the algorithm then establishes (step 304) an AAL2 connection over the direct VCC. If this setup is successful (step 305), then the algorithm returns to a monitoring state to await another connection request (step 301). If the setup is not successful, then the setup failure is first reported (step 306) to the management system and the algorithm returns to a monitoring state (step 301).

The algorithm depicted in FIG. 4 addresses many of the shortcomings of conventional systems. For example, the algorithm reallocates network resources without the involvement of the network operator, thereby making large networks manageable. The algorithm also aims to optimize the use of existing connections before attempting to establish new a VCC, thus increasing bandwidth efficiency.

While a bandwidth allocation algorithm could be implemented as shown in FIG. 4, the algorithm may also be expanded to include additional functions to make more intelligent network management decisions. For example, in some network configurations, it may be possible to meet increasing bandwidth demand by increasing the bandwidth to intermediate switches rather than establishing a new direct VCC.

FIG. 5 depicts a flow diagram for a decision algorithm allowing for an even more efficient use of network resources. As in the previous embodiment, the algorithm begins by waiting for the receipt (step 301) of a connection request. Once a connection request is received, the algorithm determines (step 401) if there are any direct VCCs from the source to the destination. If there are direct VCCs, then the algorithm checks for available CIDs and modifies the bandwidth on the direct VCCs as described in steps 302, 303, and 310 of the previous embodiment.

If there are no direct VCCs from the source to the destination or if there are no CIDs available on the direct VCCs, then the algorithm determines (step 402) if the total bandwidth to the destination exceeds a threshold. The threshold may be determined either directly by the operator or by some algorithm in the management system. If the threshold is directly set by the operator, then the operator should take into account the traffic situation in the whole network and determine the desired traffic profile between the two endpoints. If the total bandwidth exceeds the threshold, then the algorithm sets up a direct VCC to the destination as described in step 320 of the previous embodiment.

If the total bandwidth to the destination does not exceed the threshold, then the algorithm determines (step 403) if CIDs are available on any indirect VCCs. If CIDs are available, then the algorithm determines (step 404) if bandwidth is available on the VCC to the destination and may attempt to modify (step 410) the bandwidth on the VCC in a manner similar to step 310 in the previous embodiment. As before, if there are no CIDs available on indirect VCCs or if the bandwidth modification is not successful, then other existing VCCs are checked in an iterative process (steps 405, 403, 410) until either bandwidth is allocated or all of the VCCs are checked.

If no CIDs are available on any indirect VCCs or if the bandwidth on an existing VCC cannot be modified, then the algorithm establishes (step 420) at least one new indirect VCC according to a routing table. This is accomplished by setting up (step 421) a VCC to an AAL2 switch and possibly setting up an additional VCC from the switch to the destination. As can be appreciated, the routing table for a network as shown in FIG. 2 is relatively simple. However, as additional intermediate switches are introduced, the number of possible transmission paths, and the complexity of the routing table, may increase dramatically.

Once a VCC has been established, a new AAL2 connection may be set up (step 304) and the algorithm returns to wait for the next connection request (step 301). As in the previous embodiment, certain supervisory tasks, such as error reporting (step 306) and other monitoring tasks may be needed.

The invention has now been described with respect to two embodiments. In light of this disclosure, those skilled in the art will likely make alternate embodiments of this invention, such as the inclusion of additional tasks or the use of alternate networking equipment. These and other alternate embodiments are intended to fall within the scope of the claims which follow.

What is claimed is:

1. A method for optimizing network resources in an ATM network comprising the steps of:
(a) determining whether a channel identifier (“CID”) is available on a direct virtual connection channel (“VCC”) in response to a connection request;
(b) if a CID is available, then determining if bandwidth is available on the direct VCC; and
(c) if bandwidth is available on the direct VCC, then setting up an AAL2 connection on the direct VCC.

2. The method of claim 1 further comprising the step of:
(b1) setting up a new direct VCC to a destination if bandwidth is not available on the direct VCC,
wherein step (b1) is executed after step (b) and before step (c).

3. A method for optimizing network resources in an ATM network, wherein the ATM network is formed from a plurality of interconnected network nodes, the method comprising the steps of:
(a) determining whether a channel identifier (“CID”) is available on an indirect virtual connection channel (“VCC”);
(b) if the indirect VCC does not have an available CID, then checking all existing indirect VCCs for an available CID;
(c) if the indirect VCC has an available CID, then determining if bandwidth is available on the indirect VCC;
(d) if the indirect VCC does not have bandwidth available, then modifying the bandwidth on the indirect VCC; and
(e) if bandwidth is available on the indirect VCC, then setting up an AAL2 connection on the indirect VCC.

4. The method of claim 3 further comprising the steps of:
(d1) setting up at least one new indirect VCC to a destination if bandwidth is not available on any indirect VCCs,
wherein step (d1) is executed after step (d) and before step (e).

5. The method of step 4, wherein the at least one new indirect VCC is setup according to a routing table.

6. A communication network comprising:
a plurality of ATM nodes;
a plurality of direct virtual connection channels (“VCC”), wherein each direct VCC connects one of the plurality of ATM nodes to a different one of the plurality of ATM nodes;
means for determining whether a channel identifier (“CID”) is available on a direct VCC;
means for determining if bandwidth is available on the direct VCC; and
means for setting up an AAL2 connection on the direct VCC.

7. The communication network of claim 6, further comprising means for setting up a new direct VCC to a destination.

8. A communication network comprising:
a plurality of ATM nodes;
a plurality of indirect virtual connection channels (“VCC”), wherein each indirect VCC connects one of the plurality of ATM nodes to a different one of the plurality of ATM nodes;
means for determining whether a channel identifier (“CID”) is available on an indirect VCC;
means for checking all existing indirect VCCs for an available CID;
means for determining if bandwidth is available on the indirect VCC;
means for modifying the bandwidth on the indirect VCC; and
means for setting up an AAL2 connection on the indirect VCC.

9. The communication network of claim 8, further comprising means for setting up at least one new indirect VCC.

10. An ATM node comprising:
means for connecting to at least one other ATM node, the connecting means establishing a virtual connection channel (“VCC”) between the ATM node and the at least one other ATM node;
means for determining whether a channel identifier (“CID”) is available on the VCC;
means for modifying the bandwidth on the VCC; and
means for setting up an AAL2 connection on the VCC.

11. The ATM node of claim 10, further comprising means for setting up at least one new indirect VCC.
